(19) United States
(12) Patent Application Publication
(10) Pub. No.: US 2026/0073283 A1
(43) Pub. Date: Mar. 12, 2026

(54) PROGNOSTIC COMPLIANCE MODEL USING REAL-TIME INFORMATION TAXONOMY

(71) Applicant: Bank of America Corporation, Charlotte, NC (US)

(72) Inventors: Michael Sukovich, Milford, PA (US); Vinod Maghnani, Gurugram (IN); Jaya Eripilla, Little Elm, TX (US)

(21) Appl. No.: 18/829,926

(22) Filed: Sep. 10, 2024

(51) Int. Cl. G06N 20/00

(52) U.S. Cl. CPC G06N 20/00

(57) ABSTRACT

Aspects related to a prognostic compliance model using real-time information taxonomy are provided. A modeling platform may access regulation information associated with an event processing request. The platform may generate a prediction summary using a prognostic model. The prediction summary may include a predicted event processing request and information of one or more potential conflicts. The platform may generate, using the prognostic model and based on the prediction summary, a conflict alert. The conflict alert may correspond to the event processing request or predicted event processing request. The platform may output the conflict alert to a user device. The platform may receive feedback information corresponding to the conflict alert. The platform may update the prognostic model based on the feedback information.

### BACKGROUND

Aspects described herein are related to a prognostic compliance model using real-time information taxonomy. In some instances, entities such as an enterprise organization (e.g., a financial institution, and/or other institutions) may manage information subject to one or more orchestrated regulations. In some examples, requests to access the information for certain purposes may conflict with one or more regulations. Also or alternatively, certain portions of the information may require privacy-preserving protections. However, conventional systems are not capable of providing real-time alerts and conflicts reports, to users, that identify conflicts and the links between the requested use of information and the violated regulation, law, or the like that causes the conflict. Also, organizations face challenges in effectively classifying the vast volumes of information (e.g., unstructured information, streaming information, or the like) managed by the organizations, increasing the difficulty in effectively identifying conflicts with requests for the information. Traditional methods of performing information taxonomy to classify information are unable to keep pace with the rapid influx of information from, for example, social media, news articles, customer feedback, and/or other sources, leading to inefficiencies in information organization, retrieval, and analysis. Thus, there exists a need for a method of performing real-time taxonomy to dynamically and accurately classify information and, based on the classifications, identify potential conflicts and generate associated conflicts reports.

### SUMMARY

Aspects of the disclosure provide effective, efficient, scalable, and convenient technical solutions that address and overcome the technical problems associated with current methods of compliance modeling and information taxonomy. In accordance with one or more arrangements of the disclosure, a computing platform with at least one processor, a communication interface, and memory storing computer-readable instructions may receive an event processing request. The event processing request may comprise user information. The computing platform may access regulation information corresponding to a plurality of different classes of information. The computing platform may generate, using a prognostic model and based on the user information and the regulation information, a prediction summary. The prediction summary may comprise a predicted event processing request and information of one or more potential conflicts corresponding to the predicted event processing request. The computing platform may generate, using the prognostic model and based on the prediction summary, a conflict alert corresponding to at least one of the event processing request or the predicted event processing request. The computing platform may output, to a user device, the conflict alert. The computing platform may receive, from the user device and based on outputting the conflict alert, feedback information corresponding to the conflict alert. The computing platform may update, based on the feedback information, the prognostic model.

In one or more examples, the computing platform may train, based on the regulation information and historical event processing information, the prognostic model to generate prediction summaries and conflict alerts based on input of event processing requests. The computing platform may generate the prediction summary by providing the event processing request to the prognostic model as input; generating, based on the user information of the event processing request, the predicted event processing request; and identifying, based on the regulation information and the predicted event processing request, a likelihood of one or more potential regulatory conflicts occurring when processing the predicted event processing request. In one or more arrangements, the computing platform may train, based on historical privacy information, the prognostic model to perform information masking of information corresponding to the event processing request based on input of one or more prediction summaries. The computing platform may identify, by inputting the prediction summary to the prognostic model, private information corresponding to the event processing request. The computing platform may mask, based on one or more information masking techniques, the private information. The computing platform may output, to the user device, the masked private information.

In one or more examples, the computing platform may mask the private information by generating a non-fungible token corresponding to the private information. The masked private information may comprise the non-fungible token. In one or more arrangements, the feedback information may comprise an accuracy score corresponding to the masked private information. In one or more examples, the regulation information may comprise one or more extended reality (XR) regulations. In one or more arrangements, the computing platform may output the prediction summary. Outputting the prediction summary may cause display, at a user interface, of the prediction summary. In one or more examples, the computing platform may generate the conflict alert by identifying, based on the regulation information and historical conflict information, one or more regulatory conflicts corresponding to the event processing request. In one or more arrangements, the feedback information may comprise an accuracy score corresponding to the conflict alert.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for a prognostic compliance model using real-time information taxonomy in accordance with one or more example arrangements;

FIGS. 2A-2E depict an illustrative event sequence for a prognostic compliance model using real-time information taxonomy in accordance with one or more example arrangements;

FIGS. 3A-3B depict illustrative graphical user interfaces generated as part of implementing a prognostic compliance model using real-time information taxonomy in accordance with one or more example arrangements; and

FIG. 4 depicts an illustrative method for a prognostic compliance model using real-time information taxonomy in accordance with one or more example arrangements.

### DETAILED DESCRIPTION

In the following description of various illustrative arrangements, reference is made to the accompanying drawings, which form a part hereof, and in which is shown, by way of illustration, various arrangements in which aspects of the disclosure may be practiced. In some instances, other arrangements may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief description of the concepts described further herein, some aspects of the disclosure relate to a prognostic compliance model using real-time information taxonomy. In some instances, entities such as an enterprise organization (e.g., a financial institution, and/or other institutions) may require that information managed by the organization comply with a variety of regulations. Evaluating large volumes of information against a variety of regulations is a time-intensive process that can degrade the experience of a user (e.g., a customer of the enterprise organization, employee of the enterprise organization, or the like) by causing delays in identification of conflicts with the regulations. Further, organizations that manage information face difficulties in efficiently classifying the information, particularly unstructured and/or streaming information that is received in large volumes. Classifying information is a critical component of efficiently identifying conflicts with information management regulations and of preserving privacy, as certain classifications of information require the implementation of privacy-enhancing techniques to comply with one or more regulations.

Conventional systems for providing information taxonomy (e.g., classification) and evaluating information against information management regulations lack real-time access to the orchestrated regulations. Conventional systems also are unable to send alerts and/or conflict reports to a user in real-time due to the delays caused by the time-intensive process of evaluating information against regulations after the information is classified. Thus, there exists a need for a real-time taxonomy generation solution that can adapt dynamically to evolving information sources and regulations, ensuring accurate and timely classification and improving the user experience. This need coincides with the need for a method of providing real-time autoconfiguration of sensitive information with privacy-enhancing techniques and reporting alerts and conflicts to a user.

Accordingly, in some instances, entities such as an enterprise organization (e.g., a financial institution, and/or other organizations/institutions) may deploy, maintain, and/or otherwise utilize a modeling platform to provide a prognostic compliance model using real-time information taxonomy as described herein. The modeling platform may train and/or generate a prognostic model through entropy-based discretization of information to identify obsolete regulations, identify private information, adhere to legal standards, and/or otherwise evaluate information against one or more information management regulations. The prognostic model may generate predictions, in real-time, of information that may be sent and/or requested by a user in the future. Based on these predictions, the modeling platform may autoconfigure private information with one or more privacy-enhancing techniques (e.g., masking information with a non-fungible token (NFT), and/or other techniques). The prognostic model may also generate real-time conflict reports or alerts based on the predictions. For example, the prognostic model may alert a user to potential conflicts with regulations, based on identifying patterns in user requests to send or receive information, before the conflicts occur. The prognostic model may update itself based on a reward calculator to improve its efficiency and accuracy in generating predictions.

By performing the functions described above, the modeling platform described herein provides a number of benefits over conventional systems. In autoconfiguring private information, the modeling platform improves security and privacy for users by reducing the time spent identifying private information before privacy-enhancing techniques are applied. The modeling platform also improves the user experience while simultaneously ensuring compliance with regulations by generating real-time conflict reports or alerts based on predictions of future actions. The use of real-time information taxonomy enables the modeling platform to provide these benefits and reduces manpower and computing resource costs associated with conventional taxonomy methods.

In some examples, in performing the methods of deploying and/or utilizing the modeling platform as described herein, the modeling platform may train one or more machine learning models. For example, the modeling platform may train the prognostic model using one or more machine learning techniques. Training the prognostic model may configure the prognostic model to perform real-time information taxonomy. For example, the prognostic model may use a dynamic clustering algorithm to dynamically form clusters of information requested by a user and generate a hierarchical taxonomy structure. The prognostic model may utilize clustering metrics and privacy-preserving semantic clustering to incorporate differential privacy mechanisms to protect sensitive data while also generating clusters that are effective for predicting conflicts with regulations. The modeling platform may train the prognostic model to generate predictions of future compliance issues (e.g., prediction summaries, as described herein) based on evaluating historical requests from a user against a current request from the user.

These and various other aspects will be discussed more fully herein.

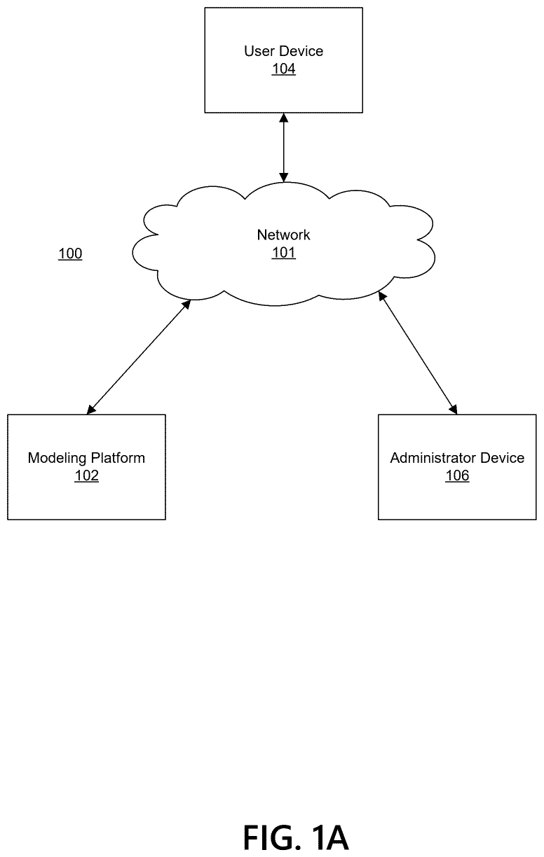

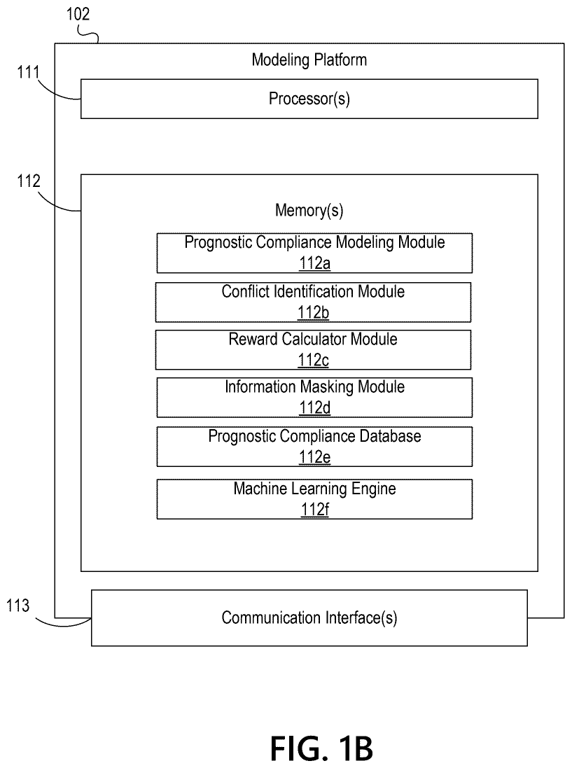

FIGS. 1A-1B depict an illustrative computing environment for a prognostic compliance model using real-time information taxonomy in accordance with one or more example arrangements. Referring to FIG. 1A, computing environment 100 may include one or more computer systems. For example, computing environment 100 may include a modeling platform 102, a user device 104, an administrator device 106, and/or other computer systems.

As described further below, modeling platform 102 may be a computer system that includes one or more computing devices (e.g., servers, laptop computer, desktop computer, mobile device, tablet, smartphone, and/or other devices) and/or other computer components (e.g., processors, memories, communication interfaces) that may be used to configure, train, and/or execute one or more machine learning models (e.g., a prognostic model, and/or other models). For example, the modeling platform 102 may train a prognostic model to generate prediction summaries, generate conflict alerts, perform information masking, and/or perform other functions described herein. The modeling platform 102 may be managed by and/or otherwise associated with an enterprise organization (e.g., a financial institution, and/or other institutions) that may, e.g., be associated with one or more additional systems (e.g., user device 104, administrator device 106, and/or other systems). In one or more instances, the modeling platform 102 may be configured to communicate with one or more systems (e.g., user device 104, administrator device 106, and/or other systems) to perform an information transfer, train artificial intelligence models via entropy-based discretization of information (e.g., to identify obsolete regulations, identify private information, adhere to legal standards, and/or otherwise evaluate information against one or more information management regulations), output a display, receive feedback for a reward calculator, and/or perform other functions. In one or more examples, the modeling platform 102 may be and/or comprise an application programming interface (API) gateway for receiving event processing requests and/or authenticating event processing requests.

The user device 104 may be a computing device (e.g., laptop computer, desktop computer, mobile device, tablet, smartphone, server, server blade, and/or other device) and/or other data storing or computing component (e.g., processors, memories, communication interfaces, databases) that may be used to transfer information between devices (e.g., event processing requests, masked information, responses to event processing requests, and/or other information) and/or perform other functions. In some examples, the user device 104 may be a device hosting and/or otherwise associated with an edge server of a centralized cloud environment. In some examples, the user device 104 may be associated with a particular user (e.g., an employee and/or a customer of the enterprise organization).

The administrator device 106 may be a computing device (e.g., laptop computer, desktop computer, mobile device, tablet, smartphone, server, server blade, and/or other device), system of devices, and/or other data storing or computing component (e.g., processors, memories, communication interfaces, databases) that may be used to transfer information (e.g., user feedback for a reward calculator, prediction summaries, and/or other information) between devices and/or perform other functions (e.g., display a user interface, and/or other functions). In some examples, the administrator device 106 may be associated with a particular entity and/or organization (e.g., financial institutions, administrative/regulatory entities, and/or other entities/organizations). In some instances, the administrator device 106 may be configured to communicate with one or more systems (e.g., modeling platform 102, and/or other systems) as part of transmitting a message, receiving a prediction summary, providing feedback, displaying a user interface, and/or performing other functions. In some instances, the administrator device 106 may be configured to display one or more graphical user interfaces (e.g., prediction summary interfaces, and/or other interfaces).

Computing environment 100 also may include one or more networks, which may interconnect modeling platform 102, user device 104, and administrator device 106. For example, computing environment 100 may include a network 101 (which may interconnect, e.g., modeling platform 102, user device 104, and administrator device 106).

In one or more arrangements, modeling platform 102, user device 104, and administrator device 106, may be any type of computing device capable of sending and/or receiving requests and processing the requests accordingly. For example, modeling platform 102, user device 104, administrator device 106, and/or the other systems included in computing environment 100 may, in some instances, be and/or include server computers, desktop computers, laptop computers, tablet computers, or the like that may include one or more processors, memories, communication interfaces, storage devices, and/or other components. As noted above, and as illustrated in greater detail below, any and/or all of modeling platform 102, user device 104, and administrator device 106 may, in some instances, be special-purpose computing devices configured to perform specific functions.

Referring to FIG. 1B, modeling platform 102 may include one or more processors 111, memory 112, and communication interface 113. A data bus may interconnect processors 111, memory 112, and communication interface 113. Communication interface 113 may be a network interface configured to support communication between modeling platform 102 and one or more networks (e.g., network 101, or the like). Communication interface 113 may be communicatively coupled to the processors 111. Memory 112 may include one or more program modules having instructions that, when executed by processors 111, cause modeling platform 102 to perform one or more functions described herein, and/or one or more databases (e.g., a prognostic compliance database 112e, or the like) that may store and/or otherwise maintain information which may be used by such program modules and/or processors 111. In some instances, the one or more program modules and/or databases may be stored by and/or maintained in different memory units of modeling platform 102 and/or by different computing devices that may form and/or otherwise make up modeling platform 102. For example, memory 112 may have, host, store, and/or include a prognostic compliance modeling module 112a, a conflict identification module 112b, a reward calculator module 112c, an information masking module 112d, a prognostic compliance database 112e, a machine learning engine 112f, and/or other modules and/or databases.

Prognostic compliance modeling module 112a may have instructions that direct and/or cause modeling platform 102 to access regulation information, generate prediction summaries (e.g., using a prognostic model, or the like), output prediction summaries, and/or perform other functions. Conflict identification module 112b may have instructions that direct and/or cause modeling platform 102 to generate conflict reports and/or alerts, authenticate event processing requests, identify potential conflicts, output conflict alerts, and/or perform other functions. Reward calculator module 112c may have instructions that direct and/or cause modeling platform 102 to use one or more machine learning techniques (e.g., reinforced deep learning, or the like) to update models (e.g., a prognostic model, or the like) based on feedback related to conflict alerts, information masking, or the like, and/or perform other functions. Information masking module 112d may have instructions that direct and/or cause modeling platform 102 to identify private information, perform one or more information masking techniques to mask private information, output masked information, and/or perform other functions. Prognostic compliance database 112e may have instructions causing modeling platform 102 to store (e.g., in memory 112) correlations used to train machine learning models, regulation information, masked information, conflict reports or alerts, historical event processing information, and/or other information. Machine learning engine 112f may have instructions to train, implement, and/or update one or more machine learning models, such as a prognostic model, and/or other machine learning models.

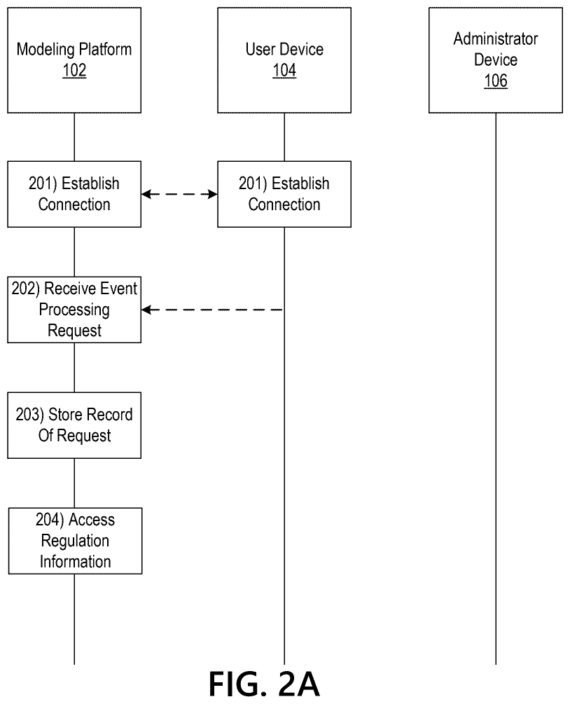

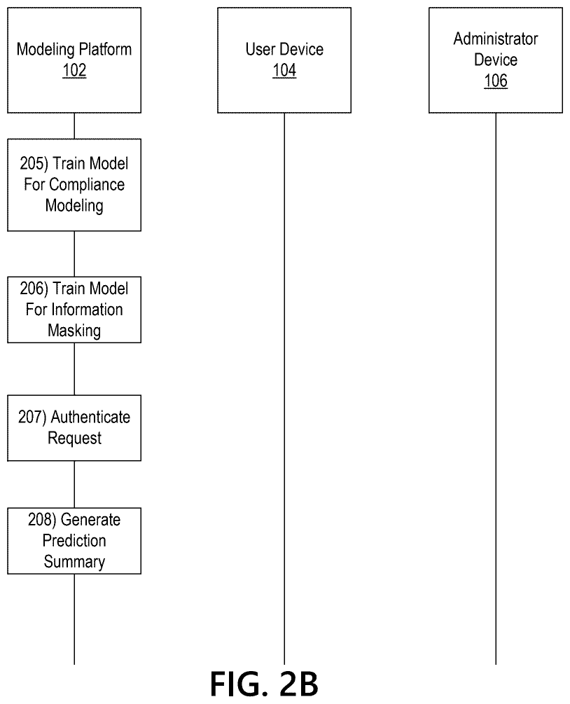

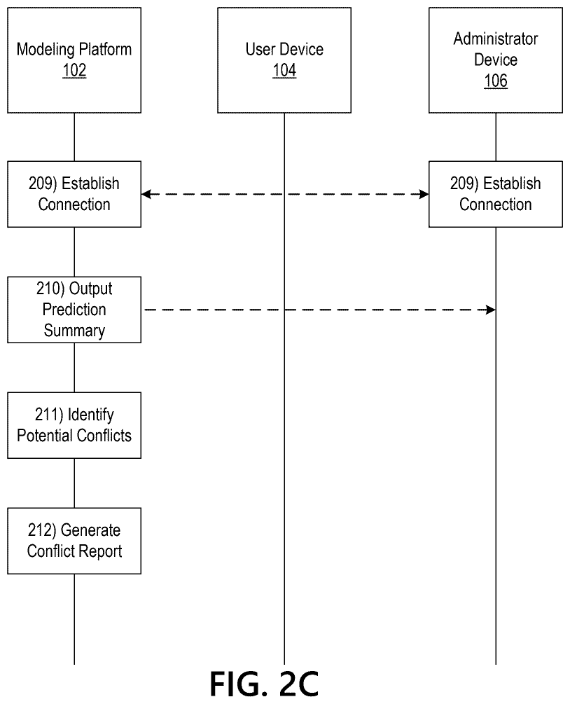

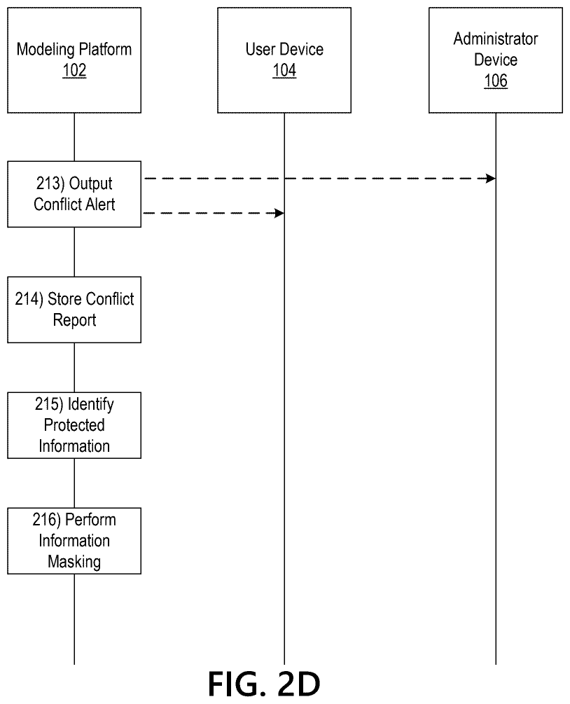

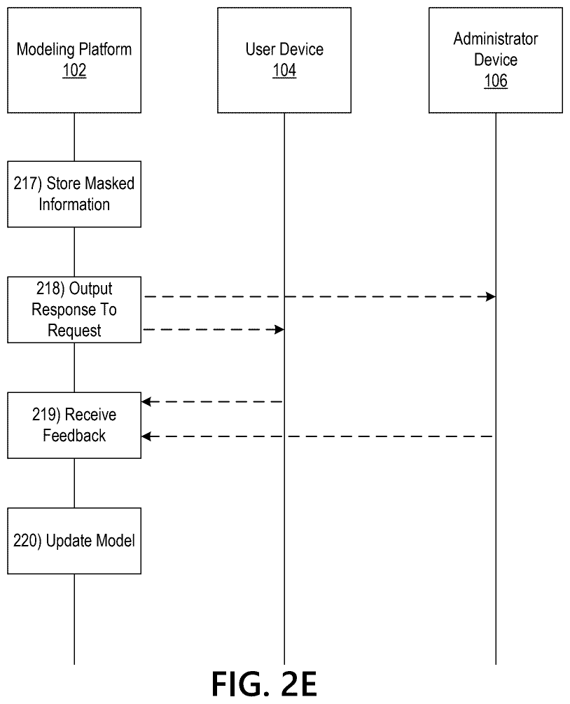

FIGS. 2A-2E depict an illustrative event sequence for a prognostic compliance model using real-time information taxonomy in accordance with one or more example arrangements. Referring to FIG. 2A, at step 201, the modeling platform 102 may establish a connection with the user device 104. For example, the modeling platform 102 may establish a first wireless data connection with the user device 104 to link the user device 104 with the modeling platform 102 (e.g., in preparation for receiving event processing requests, and/or other functions). In some instances, the modeling platform 102 may identify whether or not a connection is already established with the user device 104. If a connection is already established with the user device 104, the modeling platform 102 might not re-establish the connection. If a connection is not yet established with the user device 104, the modeling platform 102 may establish the first wireless data connection as described herein.

At step 202, the modeling platform 102 may receive an event processing request (e.g., an application programming interface (API) call, a request to access information, or the like) from the user device 104. For example, the modeling platform 102 may receive a request to access, transfer, manipulate, and/or otherwise interact with information managed by the modeling platform 102. In some examples, the modeling platform 102 may receive the event processing request via the communication interface 113 and while the first wireless data connection is established. In some examples, the event processing request may comprise user information. For example, the event processing request may comprise a username or other user identifier, account information corresponding to the user, demographic information (e.g., a geographic location associated with the user and/or the user device 104), and/or other information corresponding to the user of the user device 104. The user information may be and/or include information necessary to identify the source of the event processing request and regulation information corresponding to the event processing request (e.g., regulation information associated with the user, regulation information associated with the user device 104, regulation information associated with information the event processing request is attempting to access, and/or other information).

At step 203, the modeling platform 102 may store a record of the event processing request. In some examples, the modeling platform 102 may store a record of the event processing request to a repository (e.g., prognostic compliance database 112e, and/or other information repositories) comprising a profile, history, or the like associated with the user device 104 and/or the user of the user device 104. For example, the modeling platform 102 may include a database (e.g., prognostic compliance database 112e, or the like) comprising a number of profiles for different customers of the organization associated with the user device 104. Each profile may comprise records of a number of historical event processing requests associated with the user device 104 and/or with the user of the user device 104.

At step 204, the modeling platform 102 may access regulation information. For example, based on receiving the event processing request, the modeling platform 102 may access regulation information corresponding to a plurality of different classes of information associated with the event processing request. In some examples, the modeling platform 102 may access regulation information based on identifying classes of information (e.g., private/protected information, unstructured information, streaming information, information associated with a particular geographic area, and/or other classes) associated with information identified by the event processing request. For example, based on an event processing request for permission to retrieve information associated with a particular user account, the modeling platform 102 may access regulation information for regulations governing the handling of information from a particular geographic area associated with the source (e.g., user device 104) of the event processing request. In accessing the regulation information, the modeling platform 102 may access regulation information such as regional laws governing information management and/or transfer (e.g., state-level laws, municipality-level laws, or the like), foreign laws governing information management and/or transfer (e.g., General Data Protection Regulation (GDPR) regulations, Digital Personal Data Protection Act (DPDP) regulations, or the like), industry-specific regulations (e.g., audio/video extended reality (XR) regulations, or the like), and/or other regulation information from any number of sources. For example, the modeling platform 102 may access the regulation information from an internal repository of regulation information (e.g., memory 112, or the like) and/or from external sources, such as websites, cloud-based repositories, or the like.

Referring to FIG. 2B, at step 205, the modeling platform 102 may train a model for compliance modeling. For example, the modeling platform 102 may train a prognostic model to perform real-time information taxonomy on new information received by the organization associated with the modeling platform 102 for management and to generate prediction summaries and conflict alerts/reports based on input of event processing requests. The modeling platform 102 may train the prognostic model through entropy-based discretization of information. For example, the modeling platform 102 may use entropy-based discretization of information comprising techniques such as information splitting and/or classifying, preservation of data values for separation of information, or the like, for supervised training of a machine learning model (i.e., the prognostic model). The modeling platform 102 may, based on the entropy-based discretization, train the prognostic model to create one or more taxonomies, hierarchies, or the like classifying information as it is received by the modeling platform 102. For example, the modeling platform 102 may train the prognostic model to classify regulation information in real-time, and store records of the classification of the regulation information for later use (e.g., in accessing regulation information, generating prediction summaries, and/or performing other functions). In classifying the regulation information, based on the training, the prognostic model may identify obsolete regulations and/or assign regulations to particular classes (e.g., non-public information, public information, and/or other classes). In some examples, the modeling platform 102 may train the prognostic model to utilize a dynamic clustering algorithm to automatically group similar information (e.g., regulation information, user information, account information, or the like) as it is received by the modeling platform 102 and/or by the organization associated with the modeling platform 102. The dynamic clustering algorithm may be used by the prognostic model to generate the taxonomy/hierarchy as described herein, by clustering information according to class. It should be understood that, based on training the prognostic model through entropy-based discretization of information as described above, the modeling platform 102 may utilize real-time information taxonomy when performing one or more other functions described herein. For example, the modeling platform 102 may use the prognostic model to classify new regulation information as it is received, in real-time, to ensure accurate and up-to-date regulation information (e.g., privacy regulations, protection regulations, transmission regulations, and/or other regulation information described herein) is used to generate prediction summaries and/or conflict alerts or reports as described herein.

In addition to training the prognostic model to perform real-time information taxonomy, the modeling platform 102 may, for example, train the prognostic model to generate prediction summaries (e.g., summaries of predictions for future event processing requests that may be received from the user device 104) and/or to generate conflict reports (e.g., summaries of predicted conflicts with a current and/or predicted event processing request) and/or alerts (e.g., notifications, displays, or the like indicating confirmed or predicted conflicts for current and/or predicted event processing requests). In some instances, the modeling platform 102 may configure and/or otherwise train the prognostic model based on historical event processing information. For example, the modeling platform 102 may configure and/or otherwise train the prognostic model based on historical event processing information corresponding to event processing requests previously received from the user device 104, using the techniques described herein. The historical event processing information may be stored at a repository, such as memory 112, and associated with a user profile, report, or the like corresponding to the user of the user device 104 as described herein. The historical event processing information may comprise historical event processing requests and/or historical conflict reports indicating conflicts between historical event processing requests and regulation information. In training the prognostic model based on historical event processing information, the modeling platform 102 may configure and/or otherwise train the prognostic model to generate conflict reports and/or alerts for predicted and/or current event processing requests for access to certain classes and/or subsets of information associated with the historical event processing requests. Also or alternatively, the modeling platform 102 may train the prognostic model based on the regulation information accessed by the modeling platform 102 (e.g., as described herein at step 203). For example, the modeling platform 102 may configure and/or otherwise train the prognostic model to generate prediction summaries comprising information of one or more potential conflicts corresponding to a current or predicted event processing request based on the regulation information.

In some instances, to configure and/or otherwise train the prognostic model as described herein, the modeling platform 102 may cause the prognostic model to process the historical event processing information and/or the regulation information by applying natural language processing, natural language understanding, supervised machine learning techniques (e.g., regression, classification, neural networks, support vector machines, random forest models, naïve Bayesian models, and/or other supervised techniques), unsupervised machine learning techniques (e.g., principal component analysis, hierarchical clustering, K-means clustering, and/or other unsupervised techniques), gradient boosting, and/or other techniques. In some examples, the modeling platform 102 may train the prognostic model using different machine learning techniques for different functions.

In some examples, in configuring and/or otherwise training the prognostic model, the modeling platform 102 may store one or more correlations. For example, the modeling platform 102 may cause the prognostic model to store correlations between historical event processing information (e.g., historical conflict reports associated with historical event processing requests) and regulation information. For example, based on a historical conflict report indicating that a request to access private information associated with a user (e.g., the user of user device 104) conflicted with a data privacy regulation, the modeling platform 102 may cause the prognostic model to store a correlation between one or more data privacy regulations, included in the regulation information, and the private information associated with the user for use in predicting conflicts for predicted event processing requests. Also or alternatively, the modeling platform 102 may cause the prognostic model to store correlations between portions of the historical event processing information. For example, based on historical event processing information including a plurality of historical event processing requests for the same information (e.g., account information corresponding to a particular user, or other information), the modeling platform 102 may cause the prognostic model to store correlations between shared traits of the plurality of historical event processing requests. For example, the modeling platform 102 may cause the prognostic model to store correlations between the time the historical event processing requests were sent and/or received, the source (e.g., user device 104, or the like) of the historical event processing requests, and/or other traits.

In configuring and/or otherwise training the prognostic model, based on causing the prognostic model to store the one or more correlations, the modeling platform 102 may cause the prognostic model to generate prediction summaries and/or conflict reports using the stored correlations. In some examples, the modeling platform 102 may train the prognostic model to use the stored correlations to predict event processing requests based on input of an event processing request. For example, the modeling platform 102 may train and/or otherwise configure the prognostic model to generate a prediction summary comprising a predicted event processing request and/or information of one or more potential conflicts corresponding to the predicted event processing request based on identifying, via one or more stored correlations to historical event processing information, historical event processing requests sharing traits with the inputted event processing request. Also or alternatively, the modeling platform 102 may train and/or otherwise configure the prognostic model to use the stored correlations to generate conflict reports and/or alerts corresponding to event processing requests or predicted event processing requests. For example, the modeling platform 102 may train and/or otherwise configure the prognostic model to generate a conflict report and/or alert based on identifying, via one or more stored correlations to historical event processing information and/or to regulation information, one or more regulations an event processing request or predicted event processing request is likely to violate.

At step 206, the modeling platform 102 may configure and/or otherwise train the prognostic model for information masking. In some examples, the modeling platform 102 may configure and/or otherwise train the prognostic model for information masking using one or more techniques described herein with respect to step 205. In some examples, the modeling platform 102 may configure and/or otherwise train the prognostic model for information masking during and/or as part of step 205 rather than as a separate step. In configuring and/or otherwise training the prognostic model for information masking, the modeling platform 102 may utilize historical privacy information (e.g., historical information indicating which information, associated with a user (e.g., the user of the user device 104) is private, historical regulation information corresponding to information privacy, historical prediction summaries indicating information that should be masked, or the like). For example, the modeling platform 102 may configure and/or otherwise train the prognostic model, based on the historical privacy information, to perform information masking of information corresponding to an event processing request based on input of one or more prediction summaries.

In some examples, in configuring and/or otherwise training the prognostic model, the modeling platform 102 may store one or more correlations. For example, the modeling platform 102 may cause the prognostic model to store correlations between portions of the historical privacy information. For example, based on historical privacy information including an indication of private information associated with a user, and including a historical prediction summary indicating one or more potential conflicts with information privacy regulations, the modeling platform 102 may cause the prognostic model to store a correlation between the private information associated with the user and the one or more potential conflicts. In configuring and/or otherwise training the prognostic model, based on causing the prognostic model to store the one or more correlations, the modeling platform 102 may cause the prognostic model to perform information masking for information indicated by the stored correlations based on input of a prediction summary. For example, the modeling platform 102 may train and/or otherwise configure the prognostic model, based on a stored correlation between certain private account information associated with a user and a historical prediction summary indicating a potential conflict with a privacy regulation, to mask the private account information before responding to any event processing requests for access to the private account information. The modeling platform 102 may train and/or otherwise configure the prognostic model to implement a variety of privacy-enhancing techniques, such as redacting information, clearing metadata, generating smart non-fungible tokens (NFTs) to represent private information, and/or other techniques.

At step 207, the modeling platform 102 may authenticate an event processing request (e.g., the request received at step 202). For example, the modeling platform 102 may verify one or more credentials (e.g., usernames, passwords, single-sign on keys, or the like) corresponding to the user of the user device 104. Also or alternatively, the modeling platform 102 may confirm that the user and/or the user device 104 has access to information required to fulfill the event processing request. It should be understood that, in some examples, the modeling platform 102 may verify the one or more credentials and/or otherwise perform some or all of the authenticating of the event processing request via an API gateway and/or prior to permitting the event processing request to pass through the API gateway.

At step 208, the modeling platform 102 may generate a prediction summary. For example, the modeling platform 102 may generate a prediction summary based on inputting the regulation information into the prognostic model. In some examples, the modeling platform 102 may additionally or alternatively provide the event processing request or portions of the event processing request (e.g., user identifiers, account numbers, user profiles, and/or other user information included in the event processing request) as input to the prognostic model. In some examples, based on input of the regulation information and/or the user information the modeling platform 102 may cause the prognostic model to generate a prediction summary comprising a predicted event processing request and information of one or more potential conflicts corresponding to the predicted event processing request. For example, the prediction summary may include a predicted event processing request that, based on the event processing request and/or the user information, the prognostic model predicts the user of the user device 104 will send to the modeling platform 102 after receiving a response to the event processing request received at step 202. In some examples, based on input of the regulation information and based on providing, as additional input to the prognostic model, the predicted event processing request, the modeling platform 102 may identify a likelihood (e.g., a score, percentage, or the like) of one or more potential regulatory conflicts occurring if/when the predicted event processing request is received and/or processed. In these examples, the modeling platform 102 may cause the prognostic model to include information of the one or more potential regulatory conflicts (e.g., an identification of which regulations are violated, and/or other information) in the prediction summary.

In generating the prediction summary, the modeling platform 102 may cause the prognostic model to use one or more stored correlations previously used to train and/or otherwise configure the prognostic model. In some examples, the modeling platform 102 may cause the prognostic model to compare the event processing request and/or the user information to one or more stored correlations to historical event processing information in order to predict an event processing request. For example, based on comparing user information corresponding to the user device 104 with one or more stored correlations to historical event processing requests associated with the user device 104, the prognostic model may identify that the user of the user device 104 has historically sent an event processing request for access to a particular user account and sent a subsequent event processing request to view an account balance of the user account, on, for example, the first of each month. The prognostic model may identify, based on the comparison with the one or more stored correlations, that the event processing request received at step 202 is a request to access the particular user account and, in response, generate a predicted event processing request to view an account balance of the user account. It should be understood that this is merely an example method by which the modeling platform 102 may cause the prognostic model to generate a predicted event processing request for inclusion in the prediction summary, and that in other examples different user information may be compared with different stored correlations without departing from the scope of this disclosure.

In some examples, the modeling platform 102 may cause the prognostic model to identify information of one or more potential conflicts corresponding to the predicted event processing request. In these examples, the modeling platform 102 may cause the prognostic model to compare the predicted event processing request with one or more stored correlations. For example, the modeling platform 102 may have previously trained and/or otherwise configured the prognostic model by storing one or more correlations between historical event processing information and the regulation information. The one or more stored correlations may indicate relationships between historical conflict reports, included in the historical event processing information, and the regulation information. For example, a stored correlation may indicate an information privacy regulation, included in the regulation information, that was violated by a historical event processing request included in the historical event processing information. The modeling platform 102 may, based on comparing the one or more stored correlations with the predicted event processing request, identify a likelihood of one or more potential regulatory conflicts occurring when/if the predicted event processing request is received and/or processed by the modeling platform 102. For example, based on comparing the stored correlation indicating the information privacy regulation was violated with the predicted event processing request, the modeling platform 102 may identify a likelihood of the same information privacy regulation being violated when/if the predicted event processing request is received and/or processed by the modeling platform 102.

In some examples, in identifying the likelihood of one or more potential regulatory conflicts occurring, the modeling platform 102 may generate and/or otherwise use a similarity score between the predicted event processing request and historical event processing request associated with a stored correlation. For example, the modeling platform 102 may generate a similarity score based on a number of shared traits (e.g., information for which access is requested, source of the request, time of day the request was/will be received) between the predicted event processing request and the historical event processing request. Based on identifying that the similarity score exceeds a predetermined threshold value, the modeling platform 102 may identify a likelihood (e.g., >50%) that the predicted event processing request will create a regulatory conflict when processed. In some examples, the likelihood of the one or more potential regulatory conflicts occurring may be and/or include the similarity score. The modeling platform 102 may, based on identifying the likelihood of one or more potential regulatory conflicts occurring when processing the predicted event processing request and using the prognostic model, generate the prediction summary including information of the one or more potential conflicts corresponding to the predicted event processing request.

Referring to FIG. 2C, at step 209, the modeling platform 102 may establish a connection with the administrator device 106. For example, the modeling platform 102 may establish a second wireless data connection with the administrator device 106 to link the administrator device 106 with the modeling platform 102 (e.g., in preparation for outputting prediction summaries, causing display of a user interface, and/or other functions). In some instances, the modeling platform 102 may identify whether or not a connection is already established with the administrator device 106. If a connection is already established with the administrator device 106, the modeling platform 102 might not re-establish the connection. If a connection is not yet established with the administrator device 106, the modeling platform 102 may establish the second wireless data connection as described herein.

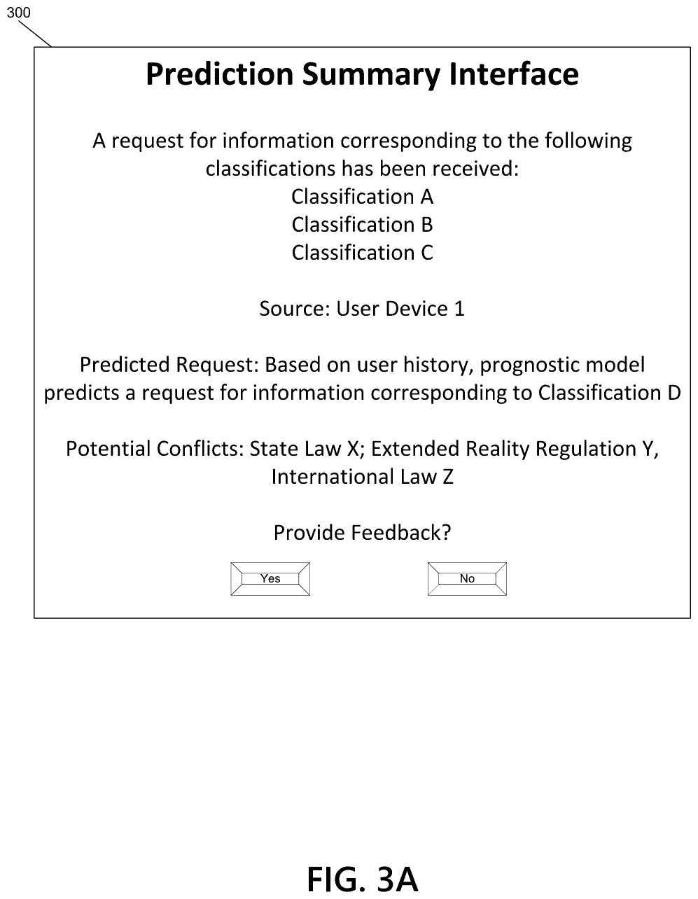

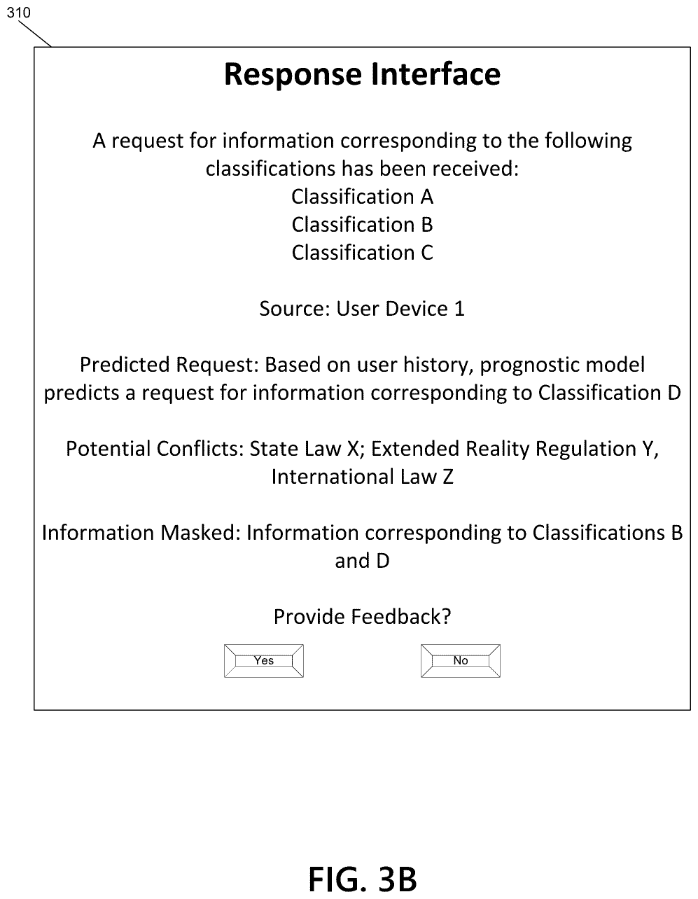

At step 210, based on generating the prediction summary, the modeling platform 102 may output the prediction summary to the administrator device 106. For example, the modeling platform 102 may output the prediction summary to the administrator device 106 for analysis and/or feedback by an administrator (e.g., an employee of the organization associated with the modeling platform 102, or the like) in order to improve the accuracy of the prognostic model. In some examples, in outputting the prediction summary, the modeling platform 102 may cause output of and/or otherwise display a user interface. In some examples, in causing output of the user interface, the modeling platform 102 may transmit and cause display of a prediction summary interface for notifying a user (e.g., an administrator of the enterprise organization associated with the modeling platform 102, and/or other users) of the predicted event processing request and potential conflicts corresponding to the event processing request. In displaying the prediction summary interface, the modeling platform 102 may cause display of a graphical user interface similar to prediction summary interface 300, which is illustrated in FIG. 3A. For example, the modeling platform 102 may output one or more instructions (via the communication interface 113 and while the second wireless data connection is established) to the administrator device 106, causing the administrator device 106 to display the prediction summary interface 300.

Referring to FIG. 3A, in some instances, the prediction summary interface 300 may include information corresponding to the event processing request, the predicted event processing request, and/or the one or more potential conflicts. For example, the prediction summary interface 300 may include information such as a summary of information classifications for information associated with the event processing request (e.g., classifications identified by the prognostic model via real-time taxonomy, as described elsewhere herein), a source of the event processing request, a description of the predicted event processing request, a list of potential conflicts, and/or other information. The prediction summary interface 300 may also display interface elements or selectable options requesting user input. For example, the prediction summary interface 300 may display one or more of: an information entry field, a button or buttons, toggle or toggles, check box or boxes, and/or other interface elements. For example, as illustrated in FIG. 3A, the interface elements may be one or more buttons the user might toggle or select to provide feedback. In some instances, based on a user selecting the toggle to provide user feedback, the user may be prompted to input the feedback (e.g., an accuracy score for the prediction summary, based on review by a human expert and/or a machine). In these examples, the administrator device 106 may provide the feedback to the modeling platform 102 (e.g., as part of a reward calculator) and the modeling platform 102 may receive the user input/feedback (e.g., as described herein with respect to step 219).

Referring back to FIG. 2C, at step 211, the modeling platform 102 may identify one or more potential conflicts. For example, the modeling platform 102 may identify any and all potential conflicts associated with the event processing request received at step 202. In some examples, the modeling platform 102 may identify the one or more potential conflicts by parsing, reading, and/or otherwise analyzing the prediction summary to identify potential conflicts with the predicted event processing request. In some examples, the modeling platform 102 may input the prediction summary into the prognostic model for analysis via natural language processing and/or other methods. Also or alternatively, the modeling platform 102 may identify one or more potential conflicts with the event processing request received at step 202. For example, the modeling platform 102 may compare the event processing request to the regulation information to identify one or more regulations that might be violated by fulfilling the event processing request. In some examples, to identify the one or more regulations that might be violated, the modeling platform 102 may use the prognostic model. For example, the modeling platform 102 may cause the prognostic model to identify, based on comparing the prediction summary to the regulation information and/or to historical conflict information (e.g., via the one or more stored correlations described herein), one or more regulatory conflicts corresponding to the event processing request and/or the predicted event processing request. For example, the prognostic model may identify a correlation between the information for which access is requested by the event processing request and one or more historical violations of regulations. In some examples, in identifying the one or more potential conflicts, the modeling platform 102 may also or alternatively access updated regulation information to determine whether any regulations associated with the one or more potential conflicts have changed, thus providing accurate and real-time identification of potential conflicts.

At step 212, the modeling platform 102 may generate a conflict report for the event processing request. The conflict report may be and/or comprise a comprehensive summary of regulatory conflicts associated with the event processing request, including: the event processing request; the predicted event processing request; the one or more potential conflicts identified at step 211, the regulation information associated with the one or more potential conflicts, and/or other information. In some examples, the conflict report may include a conflict alert (e.g., a trigger to send a message, instructions to cause a pop-up, or the like) configured to automatically notify one or more users of potential conflicts, associated with the event processing request and/or the predicted event processing request, without the need to read and/or otherwise analyze the conflict report in its entirely. The conflict alert may comprise the one or more regulatory conflicts corresponding to the event processing request and identified at step 211.

Referring to FIG. 2D, at step 213, the modeling platform 102 may output a conflict alert. The conflict alert may be and/or comprise the conflict report, and/or a conflict alert (e.g., a trigger to send a message, instructions to cause a pop-up, or the like) configured to automatically notify one or more users of potential conflicts, associated with the event processing request and/or the predicted event processing request, without the need to read and/or otherwise analyze the conflict report in its entirely (as described herein). In some examples, the modeling platform 102 may output the conflict alert to the administrator device 106 (e.g., via the communication interface 113 and while the second wireless data connection is established). Also or alternatively, in some examples, the modeling platform 102 may output the conflict alert to the user device 104 (e.g., based on or in response to a conflict alert indicating that the user of the user device 104 must take immediate action to avoid a regulatory conflict). Outputting the conflict alert to the user device 104 and/or to the administrator device 106 provides users of the user device 104 and/or the administrator device 106 with real-time updates as to potential conflicts associated with event processing requests and facilitates reducing the occurrence of regulatory conflicts. Additionally, generating and outputting real-time conflict reports and/or alerts as described herein improves the efficacy of efforts to remedy regulatory conflicts by providing comprehensive information (e.g., the regulation violated, identification of a type of conflict such as collection, storage, or transmission, and/or other information included in the conflict report or alert) that facilitates making an informed decision on how a user (e.g., of the user device 104 and/or of the administrator device 106) should address a potential conflict.

At step 214, the modeling platform 102 may store the conflict report (which may, e.g., include the conflict alert as described herein). In some examples, the modeling platform 102 may store the conflict report to a repository (e.g., prognostic compliance database 112e, and/or other information repositories) comprising a profile, history, or the like associated with the user device 104 and/or the user of the user device 104. For example, as previously described herein, the modeling platform 102 may include a database (e.g., prognostic compliance database 112e, or the like) comprising a number of profiles for different customers of the organization associated with the user device 104. Each profile may comprise records of historical conflict reports associated with the user device 104 and/or with the user of the user device 104 and may be used to update and/or otherwise train the prognostic model.

At step 215, the modeling platform 102 may identify whether the event processing request corresponds to any protected and/or private information. For example, the modeling platform 102 may identify whether the event processing request is for access to information (e.g., personal user information, financial information, and/or other information) protected by one or more information privacy regulations. In some examples, the modeling platform 102 may identify whether the event processing request corresponds to protected/private information based on inputting the prediction summary to the prognostic model. For example, based on input, by the modeling platform 102, of a prediction summary including the event processing request and/or the predicted event processing request, the prognostic model may identify a likelihood that the event processing request and/or its associated predicted event processing request is for access, management, and/or other uses of private/protected information. In some examples, based on input of the prediction summary, the modeling platform 102 may cause the prognostic model to identify protected/private information using one or more stored correlations previously used to train and/or otherwise configure the prognostic model (e.g., as described at step 206). In some examples, the modeling platform 102 may cause the prognostic model to compare some or all of the information in the prediction summary with one or more stored correlations to historical privacy information.

For example, the prognostic model may have previously stored a correlation between certain protected/private account information associated with a user and a historical prediction summary indicating a potential conflict with a privacy regulation. Based on comparing the prediction summary with the stored correlation, the modeling platform 102 may identify (e.g., via the prognostic model) that the prediction summary includes information associated with a potential conflict with the same privacy regulation. The prognostic model may, in response to the comparison, identify that the event processing request associated with the prediction summary includes and/or otherwise requests access to protected/private information.

In some examples, the modeling platform 102 may identify protected/private information based on a similarity score the prognostic model generates based on the comparison between the stored correlations and the prediction summary. In some examples, the prognostic model may use one or more machine learning algorithms to generate the similarity score. For example, the modeling platform 102 may have previously trained and/or otherwise configured the prognostic model to employ a scoring algorithm to generate similarity scores between historical privacy information and information associated with an event processing request (e.g., using the one or more stored correlations). For instance, the prognostic model may execute the scoring algorithm using the following constraints/parameters:

$$Similarity Score = ( ( \frac{( Amount of Matched Information )}{( Total Amount of Information )} ) + ( \frac{( Number of Matched Parameters )}{( Number of Compared Parameters )} ) ) * 100$$

In this example, the prognostic model may compare information requested by the event processing request and/or the predicted event processing request with historical privacy information (e.g., information that was previously masked for historical event processing requests). The amount of information (e.g., a number of bytes, a number of lines, or the like) that, based on the comparison, matches between the information requested by the event processing request, and/or the predicted event processing request, and the historical privacy information may be divided by the total amount of information requested by the event processing request and/or the predicted event processing request. The prognostic model may compare particular parameters of the event processing request and/or the predicted event processing request against parameters of a historical event processing request corresponding to historical privacy information (e.g., based on the one or more stored correlations). The compared parameters may include the respective sources of the requests, the time at which the requests were sent and/or received, and/or other parameters. The prognostic model may, based on comparing the parameters, simultaneously or near-simultaneously execute the example scoring algorithm to generate a similarity score comprising the sum of 1) the quotient of the number of parameters that match between the event processing request, and/or the predicted event processing request, and the historical event process request, and 2) the quotient of the amount of matched information divided by the total amount of information as described above, the sum multiplied by one hundred. It should be understood that this is merely one illustrative example of a scoring algorithm that may be executed by the prognostic model and that additional and/or alternative algorithms may be used without departing from the scope of this disclosure.

In identifying the protected/private information based on a similarity score, the prognostic model may compare the similarity score to a threshold. Based on determining that the similarity score meets or exceeds the threshold, the modeling platform 102 may identify that the event processing request and/or the predicted event processing request includes protected/private information. The modeling platform 102 may, based on identifying that the event processing request and/or the predicted event processing request includes protected/private information, proceed to step 216 and mask the protected/private information to provide benefits such as real-time privacy-preserving management of information. These benefits may improve over conventional systems because the protected/private information is identified based on the real-time information taxonomy and conflict identification as described herein, allowing for proactive and accurate information masking rather than conventional reactive information masking. The modeling platform 102 may, based on identifying that the event processing request and/or the predicted event processing request does not include protected/private information, proceed to step 218 without performing the functions recited at steps 216-217.

At step 216, based on identifying protected/private information corresponding to the event processing request and/or the predicted event processing request, the modeling platform 102 may perform information masking. For example, the modeling platform 102 may perform one or more information masking techniques to obscure, disguise, and/or otherwise mask the protected/private information before fulfilling the event processing request and/or before receiving the predicted event processing request. In some examples, the one or more information masking techniques may comprise modifying metadata and/or other identifying information of the protected/private information to prevent unauthorized users from viewing the protected/private information, modifying metadata and/or other identifying information of the protected/private information to disguise/display the protected/private information as other, nonprivate information when viewed by an unauthorized user, and/or other techniques. In some examples, the modeling platform 102 may mask the protected/private information by generating a smart NFT (e.g., an NFT incorporating smart contract functionality) representing the protected/private information but protecting it from unauthorized use and/or viewing. In generating the smart NFT, the modeling platform 102 may generate a synthetic version of the protected/private information and store it, to a distributed ledger, as a smart NFT. It should be understood that the information masking techniques described herein are merely examples and that any suitable information masking technique may be used without departing from the scope of this disclosure.

Referring to FIG. 2E, at step 217, the modeling platform 102 may store the masked information. In some examples, the modeling platform 102 may store the masked information to a repository (e.g., prognostic compliance database 112e, and/or other information repositories) comprising a profile, history, or the like associated with the user device 104 and/or the user of the user device 104. For example, as previously described herein, the modeling platform 102 may include a database (e.g., prognostic compliance database 112e, or the like) comprising a number of profiles for different customers of the organization associated with the user device 104. Each profile may comprise records of historical privacy information associated with the user device 104 and/or with the user of the user device 104 and may be used to update and/or otherwise train the prognostic model.

At step 218, the modeling platform 102 may output a response to the event processing request. The response to the event processing request may, in some examples, comprise information requested by the event processing request, access to the information requested by the event processing request, or the like. The response to the event processing request may further comprise the masked information, the conflict report, and/or other information generated by the modeling platform 102 while performing the functions described herein. In some examples, the modeling platform 102 may output the response to the event processing request to the user device 104 (e.g., via the communication interface 113 and while the first wireless data connection is established). Also or alternatively, in some examples the modeling platform 102 may output the response to the event processing request to the administrator device 106 (e.g., via the communication interface 113 and while the second wireless data connection is established). In these examples, the response to the event processing request may comprise the prediction summary. In some examples, in outputting the response to the event processing request, the modeling platform 102 may cause output of and/or otherwise display a user interface. In some examples, in causing output of the user interface, the modeling platform 102 may transmit and cause display of a response interface for receiving user feedback (e.g., from an administrator of the enterprise organization associated with the modeling platform 102, and/or other users). In displaying the response interface, the modeling platform 102 may cause display of a graphical user interface similar to response interface 310, which is illustrated in FIG. 3B.

Referring to FIG. 3B, in some instances, the response interface 310 may include information corresponding to the event processing request, the predicted event processing request, the masked information and/or the one or more potential conflicts. For example, the response interface 310 may include information such as a summary of information classifications for information associated with the event processing request (e.g., classifications identified by the prognostic model via real-time taxonomy, as described elsewhere herein), a source of the event processing request, a description of the predicted event processing request, a list of potential conflicts, a summary of the information that was masked and which classifications (determined via real-time taxonomy) the masked information is associated with, and/or other information. The response interface 310 may also display interface elements or selectable options requesting user input. For example, the response interface 310 may display one or more of: an information entry field, a button or buttons, toggle or toggles, check box or boxes, and/or other interface elements. For example, as illustrated in FIG. 3B, the interface elements may be one or more buttons the user might toggle or select to provide feedback. In some instances, based on a user selecting the toggle to provide user feedback, the user may be prompted to input the feedback (e.g., an accuracy score for the masked information, an accuracy score for the conflict report, and/or other feedback, based on review by a human expert and/or a machine). In these examples, the user device 104 and/or the administrator device 106 may provide the feedback to the modeling platform 102 (e.g., as part of a reward calculator) and the modeling platform 102 may receive the user input/feedback (e.g., as described herein with respect to step 219).

Referring back to FIG. 2E, at step 219, the modeling platform 102 may receive feedback. In some examples, the modeling platform 102 may receive, from the user device 104 and/or the administrator device 106, feedback (e.g., accuracy scores, performance ratings, or the like) corresponding to the prediction summary, the conflict report and/or alert, the masked information, and/or other information included in the response to the event processing request. For example, the modeling platform 102 may receive an accuracy score (e.g., an integer, a percentage, a decimal value, a fraction, a letter grade, and/or other scores) indicating a degree of success the modeling platform 102 achieved in masking information. Also or alternatively, the modeling platform 102 may receive an accuracy score corresponding to the conflict report and/or alert. For example, the modeling platform 102 may receive an accuracy score of 80%, indicating that the conflict alert identified 80% of potential conflicts associated with the event processing request.

At step 220, based on receiving the feedback, the modeling platform 102 may refine, validate, and/or otherwise update the prognostic model. For example, the modeling platform 102 may update the prognostic model by providing the feedback as input into a reward calculator included in the prognostic model. The prognostic model may use deep learning techniques to modify its behaviors, algorithms, or the like based on the feedback. By inputting the feedback into the prognostic model, the modeling platform 102 may create an iterative feedback loop that may continuously and dynamically refine the prognostic model to improve its accuracy in identifying protected/private information and/or potential regulatory conflicts. In some instances, updating the prognostic model may include causing the prognostic model to update one or more stored correlations based on the feedback. For example, the modeling platform 102 may cause the prognostic model to store new correlations and/or update existing correlations such that the prognostic model may generate conflict reports and/or alerts and identify protected/private information, based on event processing requests for the same or similar information, in future iterations of the feedback loop.

In updating the prognostic model, the modeling platform 102 may improve the accuracy of the model for generating conflict reports and/or for identifying protected/private information which may, for example, result in more efficient training of machine learning models trained by the modeling platform 102 (and may in some instances, conserve computing and/or processing power/resources in doing so). Improving the accuracy of the prognostic model may reduce regulatory violations for users (e.g., the user of the user device 104), improving the user experience when submitting event processing requests with the modeling platform 102, and/or which may provide benefits for the organization associated with the modeling platform 102 by ensuring information management procedures comply with all regulations. Improving the accuracy of the prognostic model may additionally improve protections for private information of users conducting business with the organization associated with modeling platform 102.

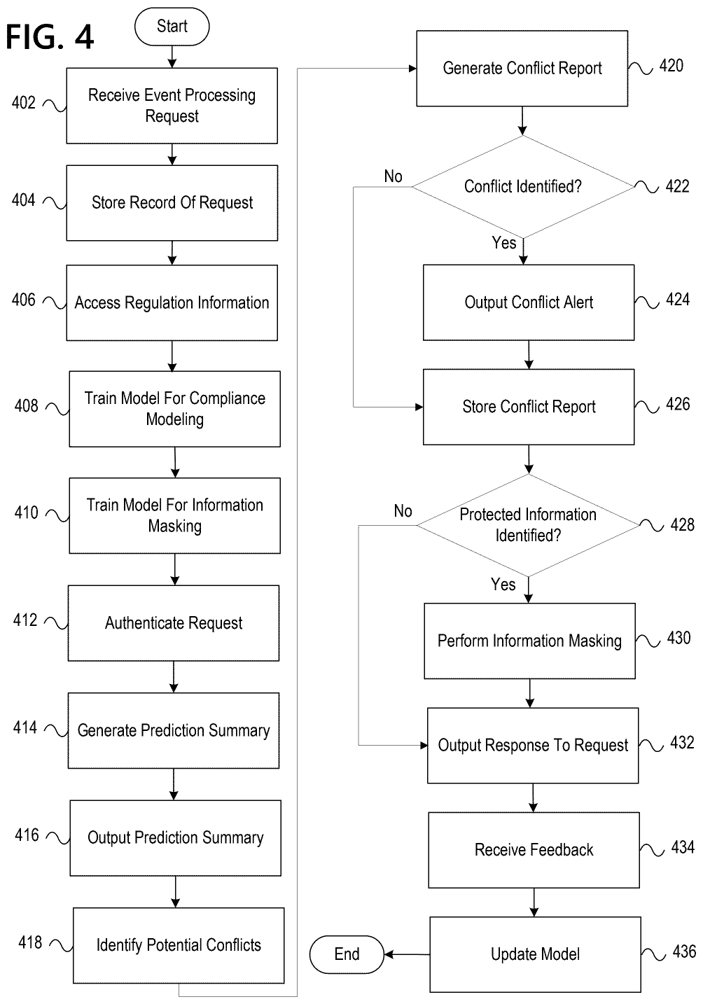

FIG. 4 depicts an illustrative method for a prognostic compliance model using real-time information taxonomy in accordance with one or more example arrangements. Referring to FIG. 4, at step 402, a computing platform having at least one processor, a communication interface, and memory may receive an event processing request. At step 404, the computing platform may store a record of the event processing request. At step 406, the computing platform may access regulation information. At step 408, the computing platform may train a model for compliance modeling. For example, the computing platform may train a prognostic model to generate prediction summaries and/or conflict alerts based on input of event processing requests. At step 410, the computing platform may train the model for information masking. For example, the computing platform may train the prognostic model to perform information masking based on input of one or more prediction summaries. At step 412, the computing platform may authenticate the event processing request. At step 414, the computing platform may generate a prediction summary. For example, the computing platform may generate a prediction summary using the prognostic model. At step 416, the computing platform may output the prediction summary. At step 418, the computing platform may identify one or more potential conflicts corresponding to the event processing request.

At step 420, the computing platform may generate a conflict report. For example, the computing platform may generate a conflict report using the prognostic model and comprising a conflict alert. At step 422, the computing platform may determine, based on the conflict report, whether any conflicts were identified. Based on determining that a conflict was identified, the computing platform may proceed to step 424 and output a conflict alert. Based on determining that no conflicts were identified, the computing platform may proceed to step 426 and store a conflict report. At step 426, the computing platform may store the conflict report. At step 428, the computing platform may attempt to identify protected information associated with the event processing request. For example, the computing platform may identify whether the event processing request involves protected information. Based on identifying protected information, the computing platform may proceed to step 430 and perform information masking. Based on identifying that the request does not involve protected information, or after performing the information masking, the computing platform may proceed to step 432 and output a response to the event processing request. For example, the computing platform may output masked information, a prediction summary, a conflict report, and/or other responses to the event processing request. At step 434, the computing platform may receive feedback. At step 436, the computing platform may update the prognostic model. For example, the computing platform may update the prognostic model based on the feedback.

One or more aspects of the disclosure may be embodied in computer-usable data or computer-executable instructions, such as in one or more program modules, executed by one or more computers or other platforms to perform the operations described herein. Generally, program modules include routines, programs, objects, components, data structures, and the like that perform particular operations or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various arrangements. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative arrangements, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative arrangements thereof. Numerous other arrangements, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, configure the computing platform to:
receive an event processing request comprising user information;
access regulation information corresponding to a plurality of different classes of information;
generate, using a prognostic model and based on the user information and the regulation information, a prediction summary comprising:
a predicted event processing request; and
information of one or more potential conflicts corresponding to the predicted event processing request;
generate, using the prognostic model and based on the prediction summary, a conflict alert corresponding to at least one of the event processing request or the predicted event processing request;
output, to a user device, the conflict alert;
receive, from the user device and based on outputting the conflict alert, feedback information corresponding to the conflict alert; and
update, based on the feedback information, the prognostic model.

2. The computing platform of claim 1, wherein the memory stores additional computer-readable instructions that, when executed by the at least one processor, further configure the computing platform to:
train, based on the regulation information and historical event processing information, the prognostic model to generate prediction summaries and conflict alerts based on input of event processing requests, and
wherein the instructions, when executed by the at least one processor, cause the computing platform to generate the prediction summary by:
providing the event processing request to the prognostic model as input;
generating, based on the user information of the event processing request, the predicted event processing request; and
identifying, based on the regulation information and the predicted event processing request, a likelihood of one or more potential regulatory conflicts occurring when processing the predicted event processing request.

3. The computing platform of claim 1, wherein the memory stores additional computer-readable instructions that, when executed by the at least one processor, further configure the computing platform to:
train, based on historical privacy information, the prognostic model to perform information masking of information corresponding to the event processing request based on input of one or more prediction summaries;
identify, by inputting the prediction summary to the prognostic model, private information corresponding to the event processing request;
mask, based on one or more information masking techniques, the private information; and
output, to the user device, the masked private information.

4. The computing platform of claim 3, wherein the instructions when executed by the at least one processor, cause the computing platform to mask the private information by:
generating a non-fungible token corresponding to the private information, and
wherein the masked private information comprises the non-fungible token.

5. The computing platform of claim 3, wherein the feedback information comprises an accuracy score corresponding to the masked private information.

6. The computing platform of claim 1, wherein the regulation information comprises one or more extended reality (XR) regulations.

7. The computing platform of claim 1, wherein the memory stores additional computer-readable instructions that, when executed by the at least one processor, further configure the computing platform to:
output the prediction summary, and
wherein outputting the prediction summary causes display, at a user interface, of the prediction summary.

8. The computing platform of claim 1, wherein the instructions, when executed by the at least one processor, cause the computing platform to generate the conflict alert by:
identifying, based on the regulation information and historical conflict information, one or more regulatory conflicts corresponding to the event processing request.

9. The computing platform of claim 1, wherein the feedback information comprises an accuracy score corresponding to the conflict alert.

10. A method comprising:
at a computing device comprising at least one processor, a communication interface, and memory:
receiving an event processing request comprising user information;
accessing regulation information corresponding to a plurality of different classes of information;
generating, using a prognostic model and based on the user information and the regulation information, a prediction summary comprising:
a predicted event processing request; and
information of one or more potential conflicts corresponding to the predicted event processing request;
generating, using the prognostic model and based on the prediction summary, a conflict alert corresponding to at least one of the event processing request or the predicted event processing request;
outputting, to a user device, the conflict alert;
receiving, from the user device and based on outputting the conflict alert, feedback information corresponding to the conflict alert; and
updating, based on the feedback information, the prognostic model.

11. The method of claim 10, further comprising:
training, based on the regulation information and historical event processing information, the prognostic model to generate prediction summaries and conflict alerts based on input of event processing requests, and
wherein generating the prediction summary comprises:
providing the event processing request to the prognostic model as input;
generating, based on the user information of the event processing request, the predicted event processing request; and
identifying, based on the regulation information and the predicted event processing request, a likelihood of one or more potential regulatory conflicts occurring when processing the predicted event processing request.

12. The method of claim 10, further comprising:
training, based on historical privacy information, the prognostic model to perform information masking of information corresponding to the event processing request based on input of one or more prediction summaries;
identifying, by inputting the prediction summary to the prognostic model, private information corresponding to the event processing request;
masking, based on one or more information masking techniques, the private information; and
outputting, to the user device, the masked private information.

13. The method of claim 12, wherein the masking the private information comprises:
generating a non-fungible token corresponding to the private information, and
wherein the masked private information comprises the non-fungible token.

14. The method of claim 10, wherein the regulation information comprises one or more extended reality (XR) regulations.

15. The method of claim 10, further comprising:
outputting the prediction summary, and
wherein outputting the prediction summary causes display, at a user interface, of the prediction summary.

16. The method of claim 10, wherein generating the conflict alert comprises:
identifying, based on the regulation information and historical conflict information, one or more regulatory conflicts corresponding to the event processing request.

17. One or more non-transitory computer-readable media storing instructions that, when executed by a computing platform comprising at least one processor, a communication interface, and memory, cause the computing platform to:
receive an event processing request comprising user information;
access regulation information corresponding to a plurality of different classes of information;
generate, using a prognostic model and based on the user information and the regulation information, a prediction summary comprising:
a predicted event processing request; and
information of one or more potential conflicts corresponding to the predicted event processing request;
generate, using the prognostic model and based on the prediction summary, a conflict alert corresponding to at least one of the event processing request or the predicted event processing request;
output, to a user device, the conflict alert;
receive, from the user device and based on outputting the conflict alert, feedback information corresponding to the conflict alert; and
update, based on the feedback information, the prognostic model.

18. The one or more non-transitory computer-readable media of claim 17, storing additional instructions that, when executed, further cause the computing platform to:
train, based on the regulation information and historical event processing information, the prognostic model to generate prediction summaries and conflict alerts based on input of event processing requests, and
wherein the instructions, when executed by the at least one processor, cause the computing platform to generate the prediction summary by:
providing the event processing request to the prognostic model as input;
generating, based on the user information of the event processing request, the predicted event processing request; and
identifying, based on the regulation information and the predicted event processing request, a likelihood of one or more potential regulatory conflicts occurring when processing the predicted event processing request.

19. The one or more non-transitory computer-readable media of claim 17, storing additional instructions that, when executed, further cause the computing platform to:
train, based on historical privacy information, the prognostic model to perform information masking of information corresponding to the event processing request based on input of one or more prediction summaries;
identify, by inputting the prediction summary to the prognostic model, private information corresponding to the event processing request;
mask, based on one or more information masking techniques, the private information; and
output, to the user device, the masked private information.

20. The one or more non-transitory computer-readable media of claim 17, wherein the regulation information comprises one or more extended reality (XR) regulations.
